(19) United States
(12) Patent Application Publication
(10) Pub. No.: US 2025/0316797 A1
(43) Pub. Date: Oct. 9, 2025

(54) INTERMEDIATE ASSEMBLY OF POUCH-TYPE SECONDARY BATTERY AND METHOD FOR MANUFACTURING POUCH-TYPE SECONDARY BATTERY

(71) Applicant: SK ON CO., LTD., Seoul (KR)

(72) Inventor: Yea-Eun KIM, Daejeon (KR)

(21) Appl. No.: 18/863,338

(22) PCT Filed: Aug. 1, 2023
(86) PCT No.: PCT/KR2023/011259

§ 371 Date: Nov. 6, 2024

(30) Foreign Application Priority Data
Nov. 22, 2022 (KR) 10-2022-0157051

(51) Int. Cl. H01M 50/105; H01M 10/04; H01M 50/211

(52) U.S. Cl. CPC H01M 50/105; H01M 10/0436; H01M 50/211

(57) ABSTRACT

A method for manufacturing a pouch-type secondary battery according to an embodiment of the present invention may comprise: a step for preparing a pouch-type case that has two first cell accommodation parts for accommodating a first electrode assembly, two second cell accommodation parts for accommodating a second electrode assembly, and two gas collection parts for accommodating gas; an accommodation chamber-forming step for forming a first cell accommodation chamber for accommodating the first electrode assembly and a second cell accommodation chamber for accommodating the second electrode assembly, the first cell accommodation chamber being formed by folding the two first cell accommodation parts so that the first cell accommodation parts face each other, and the second cell accommodation chamber being formed by folding the two second cell accommodation parts so that the second cell accommodation parts face each other, and a gas chamber-forming step for forming a gas chamber.

### TECHNICAL FIELD

The present disclosure relates to an intermediate assembly of a pouch-type secondary battery and a method for manufacturing a pouch-type secondary battery.

### BACKGROUND ART

Recently, as mobile electronic devices have rapidly become smaller and lighter, demand for a secondary battery as an energy source has rapidly increased. A secondary battery refers to a battery that can be repeatedly charged and discharged because mutual conversion between chemical energy and electrical energy is reversible.

Secondary batteries may be largely divided into a cylindrical battery, a prismatic battery, and a pouch-type battery, depending on an appearance thereof. Thereamong, demand for a thin prismatic battery and pouch-type battery is increasing due to the trend for miniaturization of mobile electronic devices, and in particular, interest in a pouch-type battery, which is easily deformed and has low manufacturing costs, is increasing.

In the case of a pouch-type battery, an electrode assembly is accommodated inside a case in the form of a laminate sheet including a resin layer and a metal layer.

During a process of manufacturing a secondary battery cell, an electrolyte is injected into a case in which an electrode assembly is accommodated. After the process of injecting an electrolyte, excess electrolyte gas generated during the electrolyte injection process should be discharged from case. To this end, a gas chamber connected to the interior of the case in which the electrode assembly is accommodated is formed. The gas chamber is then removed through a cutting process.

In order to manufacture one cell, an injection process, a degassing process, and a gas chamber cutting process are performed sequentially. When the processes are performed for each cell to manufacture multiple cells, there is a problem that a process speed is limited. In addition, since a material required for forming a gas chamber is required for each cell, there is a problem that there is a lot of wastage of materials.

### SUMMARY OF INVENTION

### Technical Problem

An aspect of the present disclosure is to provide an intermediate assembly of a pouch-type secondary battery and a method for manufacturing the pouch-type secondary battery, reducing a material of a pouch-type secondary battery and improving a production speed in the process of manufacturing a pouch-type secondary battery.

### Solution to Problem

According to an aspect of the present disclosure, provided is a method for manufacturing a pouch-type secondary battery, the method including: preparing a pouch-type case having two first cell accommodating portions for accommodating a first electrode assembly, two second cell accommodating portions for accommodating a second electrode assembly, and two gas collection portions for accommodating gas; an accommodating chamber forming operation for forming a first cell accommodating chamber for accommodating the first electrode assembly, the first cell accommodating chamber being formed by folding the two first cell accommodating portions so that the first cell accommodating portions face each other, and a second cell accommodating chamber for accommodating the second electrode assembly, the second cell accommodating chamber being formed by folding the two second cell accommodating portions so that the second cell accommodating portions face each other; and a gas chamber forming operation for forming a gas chamber by folding the two gas collection portions so that the gas collection portions face each other.

In this case, in a plan view of the pouch-type case while unfolded, the two first cell accommodating portions and the two second cell accommodating portions may be adjacent to each other, respectively, any one first cell accommodating portion of the two first cell accommodating portions and any one second cell accommodating portion of the two second cell accommodating portions may be adjacent to each other, and the two gas collection portions may be disposed at both ends of the pouch-type case.

In the accommodating chamber forming operation, the first cell accommodating chamber may be formed by folding a first fold portion formed between the two first cell accommodating portions, adjacent to each other, and the second cell accommodating chamber may be formed by folding a second fold portion formed between the two second cell accommodating portions, adjacent to each other.

In addition, the first cell accommodating chamber may be connected to the gas chamber through a first connection portion, the second cell accommodating chamber may be connected to the gas chamber through a second connection portion, and the first connection portion and the second connection portion may be connected to a third connection portion, to be connected to the gas chamber.

A portion of the first connection portion, the second connection portion, and the third connection portion may form a gas communication port in an unsealed state, and gas from the first cell accommodating chamber and the second cell accommodating chamber may move to the gas chamber through the gas communication port.

In addition, the method for manufacturing a pouch-type secondary battery may include sealing the gas communication port.

The method for manufacturing a pouch-type secondary battery may include a sealing portion cutting operation for cutting a portion in which the first connection portion, the second connection portion, and the third connection portion are connected.

In addition, in the sealing portion cutting operation, the portion in which the first connection portion, the second connection portion, and the third connection portion are connected may be cut so that the first cell accommodating chamber and the second cell accommodating chamber are connected.

The method for manufacturing a pouch-type secondary battery may include disposing a support member between the first connection portion and the second connection portion.

In addition, the support member may have a triangular pillar shape.

In addition, the method for manufacturing a pouch-type secondary battery may include cutting the portion in which the first connection portion, the second connection portion, and the third connection portion are connected so that the first cell accommodating chamber and the second cell accommodating chamber are separated.

According to an aspect of the present disclosure, an intermediate assembly of a pouch-type secondary battery may include a plurality of battery cells including a cell accommodating chamber in which an electrode assembly is accommodated; and a gas chamber respectively connected to the interior of the plurality of battery cells; wherein the cell accommodating chamber and the gas chamber may be internally connected by a gas communication port.

In this case, the plurality of battery cells may include a first cell accommodating chamber and a second cell accommodating chamber, wherein the first cell accommodating chamber may be connected to the gas chamber by a first connection portion, and the second cell accommodating chamber may be connected to the gas chamber by a second connection portion.

The intermediate assembly of a pouch-type secondary battery may include a third connection portion connecting the first connection portion, the second connection portion, and the gas chamber.

In addition, the gas communication port may be formed in an unsealed portion of the first connection portion, the second connection portion, and the third connection portion.

### Advantageous Effects of Invention

As set forth above, according to an embodiment of the present disclosure, the effect of reducing a material of a pouch-type secondary battery may be obtained.

In addition, according to an embodiment of the present disclosure, a production speed in the process of manufacturing a pouch-type secondary battery may be improved.

### BRIEF DESCRIPTION OF DRAWINGS

FIG. 1 is a plan view and a perspective view of a pouch-type case and a perspective view of an electrode assembly.

FIG. 2 is a plan view and a perspective view of a pouch-type case in which a first cell accommodating chamber is formed.

FIG. 3 is a plan view and a perspective view of a pouch-type case in which a first cell accommodating chamber and a second cell accommodating chamber are formed.

FIG. 4 is a cross-sectional view of the perspective view of FIG. 3 taken along the line I-I′.

FIG. 5 is a cross-sectional view illustrating that a gas chamber fold portion is folded in FIG. 4.

FIG. 6 is a cross-sectional view illustrating that a gas chamber is formed in FIG. 5.

FIG. 7 is a perspective view of an intermediate assembly of a pouch-type secondary battery in which a gas chamber is formed.

FIG. 8 is a front view of FIG. 7.

FIG. 9 is a cross-sectional view of a gas communication port illustrating a flow of moving gas.

FIG. 10 is a perspective view of the intermediate assembly of the pouch-type secondary battery of FIG. 7, in which a gas communication port is sealed.

FIG. 11 is a perspective view of a gas chamber separated (cut) from the intermediate assembly of the pouch-type secondary battery of FIG. 10, and a perspective view of the pouch-type secondary battery in which two cells are connected.

FIG. 12 is a perspective view of an intermediate assembly of a pouch-type secondary battery in which a support member is disposed.

FIG. 13 is a front view of FIG. 12.

FIG. 14 is a perspective view of a gas chamber separated (cut) from the intermediate assembly of the pouch-type secondary battery of FIG. 10, and a perspective view of a pouch-type secondary battery in which two cells are separated.

### MODE FOR INVENTION

Prior to the detailed description of the present disclosure, the terms or words used in the present specification and claims described below should not be construed as being limited to common or dictionary meanings, and the inventor intends to use his/her invention in the best way. Based on the principle that terms may be properly defined for description, they should be interpreted as having meanings and concepts consistent with the technical spirit of the present disclosure. Therefore, the embodiments described in this specification and the configurations shown in the drawings are only the most preferred embodiments of the present disclosure, and do not represent all of the technical spirit of the present disclosure, so it should be understood that there may be various equivalents and modifications that can be substituted therefor at the time of this application.

Hereinafter, preferred embodiments of the present disclosure will be described in detail with reference to the attached drawings. In this case, it should be noted that in the attached drawings, the same components are indicated by the same reference symbols whenever possible. In addition, detailed descriptions of functions and configurations known in the art that may obscure the gist of the present disclosure will be omitted. For the same reason, in the accompanying drawings, some components are exaggerated, omitted, or schematically shown, and the size of each component does not entirely reflect the actual size.

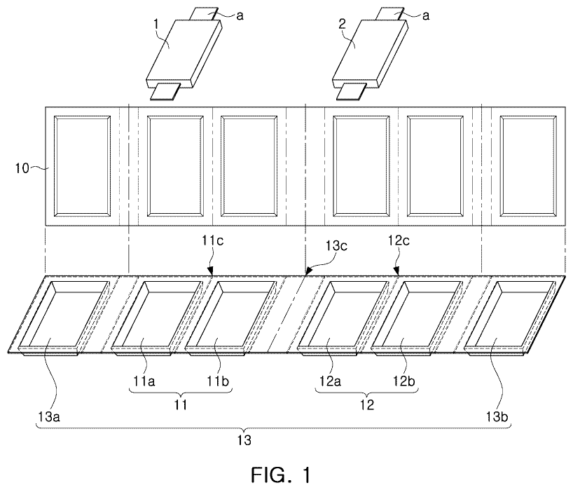

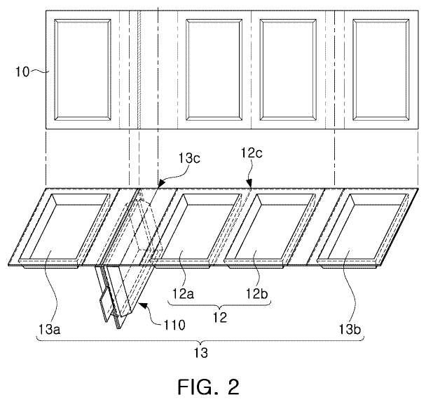

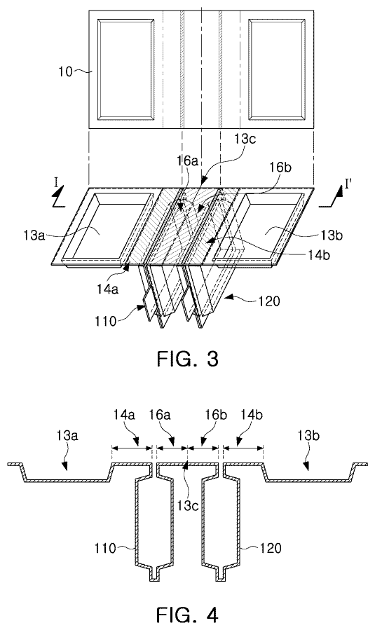

FIG. 1 is a plan view and a perspective view of a pouch-type case 10 and a perspective view of electrode assemblies 1 and 2. FIG. 2 is a plan view and a perspective view of a pouch-type case 10 in which a first cell accommodating chamber 110 is formed. FIG. 3 is a plan view and a perspective view of a pouch-type case 10 in which a first cell accommodating chamber 110 and a second cell accommodating chamber 120 are formed.

Referring to FIGS. 1 to 3, a method for manufacturing a pouch-type secondary battery according to an embodiment of the present disclosure will be described. In the following description, the description thereof is given based on the manufacturing of two cells, but the present disclosure is not limited thereto and includes manufacturing of n cells, n is a natural number greater than or equal to 2.

The method for manufacturing a pouch-type secondary battery according to an embodiment of the present disclosure may include preparing a pouch-type case 10, forming accommodating chambers 110 and 120, and forming a gas chamber 130.

In the preparing a pouch-type case 10, as illustrated in FIG. 1, a pouch-type case 10 having two first cell accommodating portions 11a and 11b for accommodating a first electrode assembly 1, two second cell accommodating portions 12a and 12b for accommodating a second electrode assembly 2, and two gas collection portions 13a and 13b for accommodating gas, is provided.

In a plan view of the pouch-type case 10 while unfolded, two first cell accommodating portions 11a and 11b and two second cell accommodating portions may be disposed to be adjacent to each other, respectively, any one first cell accommodating portion of the two first cell accommodating portions 11a and 11b and any one second cell accommodating portion of the two second cell accommodating portions 12a and 12b may be disposed to be adjacent to each other. The two gas collection portions 13a and 13b may be disposed at both ends of the pouch-type case 10. For example, the first gas collection portion 13a, the first cell accommodating portion 11a, the first cell accommodating portion 11b, the second cell accommodating portion 12a, the second cell accommodating portion 12b, and the second gas collection portion 13b may be disposed in order.

In the accommodating chamber forming operation, as illustrated in FIG. 2, a first cell accommodating chamber 110 for accommodating the first electrode assembly 1 is formed by folding the two first cell accommodating portions 11a and 11b so that the first cell accommodating portions face each other. In addition, as illustrated in FIG. 3, a second cell accommodating chamber 110 for accommodating the second electrode assembly 2 is formed by folding the two second cell accommodating portions 12a and 12b so that the second cell accommodating portions face each other.

Referring to FIGS. 1 and 2, the first electrode assembly 1 is accommodated in one of the two first cell accommodating portions 11a and 11b. Thereafter, the two first cell accommodating portions 11a and 11b are folded so that an accommodating space of each of the first cell accommodating portions 11a and 11b face each other, based on a first fold portion 11c. As the first fold portion 11c is folded, the two first cell accommodating portions 11a and 11b are combined to form a first cell accommodating chamber 110.

Referring to FIGS. 1 to 3, the second electrode assembly 2 is accommodated in one of the two second cell accommodating portions 12a and 12b. Thereafter, the two second cell accommodating portions 12a and 12b are folded so that an accommodating space of each of the second cell accommodating portions 12a and 12b face each other, based on a second fold portion 12c. As the second fold portion 12c is folded, the two second cell accommodating portions 12a and 12b are combined to form a second cell accommodating chamber 120.

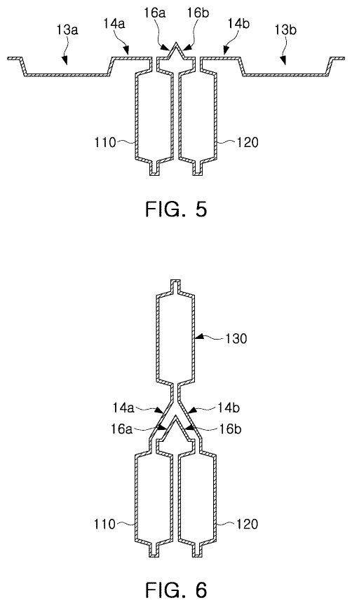

FIG. 4 is a cross-sectional view taken along the I-I′ direction of the perspective view of FIG. 3. FIG. 5 is a cross-sectional view illustrating that a gas chamber folding 13c is folded in FIG. 4. FIG. 6 is a cross-sectional view illustrating that a gas chamber 130 is formed in FIG. 5. In the cross-sectional views of FIGS. 4 to 6, for convenience, a protruding portion of electrode assemblies 1 and 2 and an electrode tab (a) is not shown.

Hereinafter, referring to FIGS. 3 to 6, an operation of forming a gas chamber 130 will be described.

In the operation of forming a gas chamber 130, a gas chamber 130 is formed by folding two gas collection portions 13a and 13b so that the gas collection portions face each other. As illustrated in FIG. 3, after the first cell accommodating chamber 110 and the second cell accommodating chamber 120 are formed, the gas chamber 130 is formed.

First, referring to FIGS. 4 and 5, with respect to a gas chamber fold portion 13c, a third surface 16a, which is a left side of the gas chamber fold portion 13c and a fourth surface 16b, which is a right side, are folded to face outwardly. That is, as illustrated in FIG. 5, as folding occurs, the gas chamber fold portion 13c is disposed in a direction which a distance from the first cell accommodating chamber 110 and the second cell accommodating chamber 120 increases.

Thereafter, referring to FIGS. 5 and 6, a first surface 14a, which is a right side of the first gas collection portion 13a, is folded to be in contact with the third surface 16a, and a second surface 14b, which is a right side of the second gas collection portion 13b is folded to be in contact with the fourth surface 16b. As the process is performed, the first gas collection portion 13a and the second gas collection portion 13b are folded to face each other, to form a gas chamber 130.

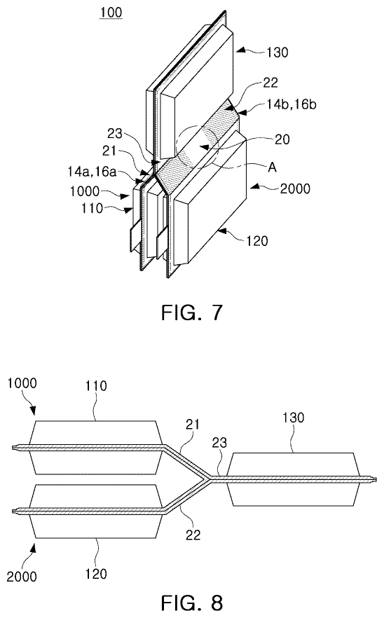

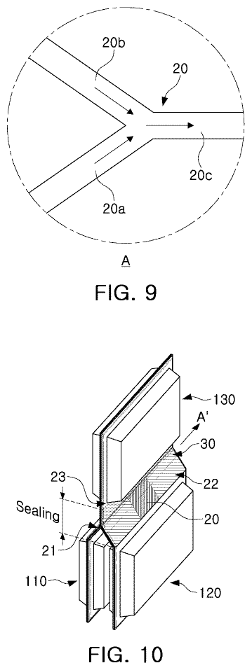

FIG. 7 is a perspective view of an intermediate assembly 100 of a pouch-type secondary battery in which a gas chamber 130 is formed, and FIG. 8 is a front view of FIG. 7. FIG. 9 is a cross-sectional view of a gas communication portion 20 illustrating a flow of moving gas.

Through the above-described process, as shown in FIG. 7, one gas chamber 130, and a first cell accommodating chamber 110 and a second cell accommodating chamber 120 connected to the gas chamber 130 are formed. In this case, referring to FIG. 8, the first cell accommodating chamber 110 is connected by a first connection portion 21, and the second cell accommodating chamber 120 is connected by a second connection portion 22. The first connection portion 21 and the second connection portion 22 are combined by a third connection portion 23, and are connected to the gas chamber 130.

According to an embodiment of the present disclosure, sealing may be performed along outer portions of the first cell accommodating chamber 110, the second cell accommodating chamber 120, and the gas chamber 130. In this case, sealing is performed while an electrode tab (a) is exposed externally. In this case, a location of an electrolyte injection port (not shown) into which an electrolyte can be injected may not be sealed. The location of the electrolyte injection port (not shown) may be any location in which an electrolyte can be injected into the first cell accommodating chamber 110 and the second cell accommodating chamber 120.

Electrolyte injection may be performed simultaneously in the first cell accommodating chamber 110 and the second cell accommodating chamber 120, or may be performed separately. After the electrolyte injection, an electrolyte injection port (not shown) may also be sealed by thermal fusion.

In addition, a portion of the first connection portion 21, the second connection portion 22, and the third connection portion 23, disposed between the first cell accommodating chamber 110, the second cell accommodating chamber 120, and the gas chamber 130 may form a gas communication port 20. The first connection portion 21, the second connection portion 22, and the third connection portion 23, disposed between the first cell accommodating chamber 110, the second cell accommodating chamber 120, and the gas chamber 130 are sealed, except for the portion thereof forming the gas communication port 20. That is, a portion of the portion in which the first cell accommodating chamber 110, the second cell accommodating chamber 120, and the gas chamber 130 are connected, may not be sealed, so that an electrolyte may be injected into the first cell accommodating chamber 110 and the second cell accommodating chamber 120 and gas discharged from the first cell accommodating chamber 110 and the second cell accommodating chamber 120 may move to the gas chamber 130. Therefore, the portion thereof in which sealing is not performed becomes a gas pipe 20. FIG. 7 illustrates that a gas communication port 20 is disposed in the middle of the connection portions 21, 22, and 23 based on a longitudinal direction of the first cell accommodating chamber 110, the second cell accommodating chamber 120, and the gas chamber 130, but is not limited thereto, and may be disposed at the ends of the connection portions 21, 22, and 23.

After electrolyte injection, gas generated in the first cell accommodating chamber 110 and the second cell accommodating chamber 120 moves to the gas chamber 130 through the gas communication port 20. Referring to FIG. 9, gas generated in the first cell accommodating chamber 110 moves through a first gas communication connection port 20a, and gas generated in the second cell accommodating chamber 120 moves through a second gas communication connection port 20b. The gas moved to the first gas communication connection port 20a and the second gas communication connection port 20b is combined through a third gas communication connection port 20c and is moved to the gas chamber 130.

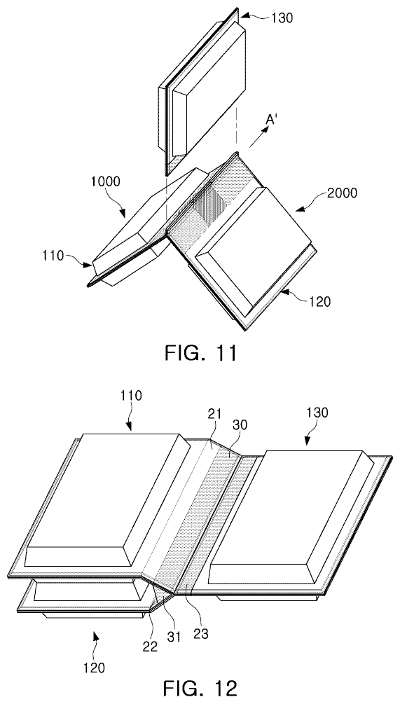

FIG. 10 is a perspective view of an intermediate assembly 100 of a pouch-type secondary battery of FIG. 7 in which a gas communication portion 20 is sealed. FIG. 11 is a perspective view of a gas chamber 130 cut from the intermediate assembly 100 of the pouch-type secondary battery of FIG. 10, and is a perspective view of a pouch-type secondary battery in which two cells 1000 and 2000 are connected.

Referring to FIG. 10, sealing is performed between the first cell accommodating chamber 110, the second cell accommodating chamber 120, and the gas chamber 130, including the unsealed gas communication port 20. Thereafter, referring to FIG. 11, cutting is performed in an A′ direction to separate the gas chamber 130. FIG. 11 illustrates an intermediate assembly 100 of a pouch-type secondary battery with a third connection portion 23 cut. Therefore, a plurality of cells 100 and 200 are manufactured using one gas chamber 130. In this case, the first cell accommodating chamber 110 and the second cell accommodating chamber 120 are connected to each other, and has a structure in which the first cell 1000 and the second cell 200 are connected to each other.

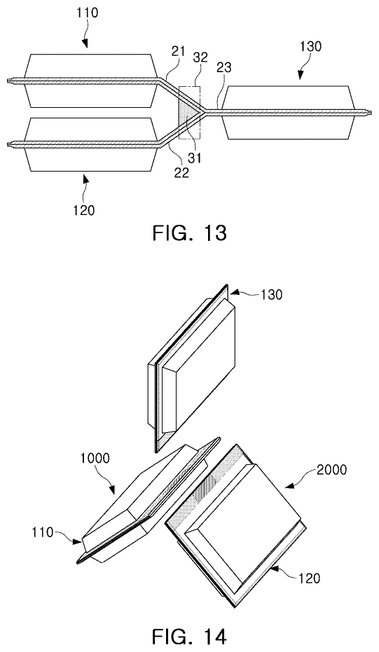

FIG. 12 is a perspective view of an intermediate assembly 100 of a pouch-type secondary battery in which a support member 31 is disposed, and FIG. 13 is a front view of FIG. 12. FIG. 14 is a perspective view of a gas chamber 130 separated (cut) from the intermediate assembly 100 of the pouch-type secondary battery of FIG. 10, and a perspective view of a pouch-type secondary battery in which two cells 1000 and 2000 are separated.

Referring to FIGS. 12 and 13, a support member 31 is disposed between the first cell accommodating chamber 110 and the second cell accommodating chamber 120. Therefore, when a sealing portion 30 is formed, the first connection portion 21 and the second connection portion 22 are separately sealed with the support member 31 interposed therebetween. When the support member 31 is removed, and cutting is performed at a location of the first connection portion 21 and the second connection portion 22, at which the support member 31 was located, the gas chamber 130 is separated, and at the same time, the first cell accommodating chamber 110 and the second cell accommodating chamber 120 are also separated. Therefore, as illustrated in FIG. 14, a pouch-type secondary battery having a structure in which the first cell 1000 and the second cell 2000 are separated by one gas chamber 130 is manufactured.

Hereinafter, an intermediate assembly 100 of a pouch-type secondary battery according to an embodiment of the present disclosure is further described with reference to FIGS. 7, 10, and 11.

The intermediate assembly 100 of a pouch-type secondary battery according to an embodiment of the present disclosure includes a plurality of battery cells 1000 and 2000, and a gas chamber 130.

The plurality of battery cells 1000 and 2000 may include a first cell 1000 and a second cell 2000. The first cell 1000 includes a first cell accommodating chamber 110 in which a first electrode assembly 1 is accommodated, and the second cell 2000 includes a second cell accommodating chamber 120 in which a second electrode assembly 2 is accommodated.

The gas chamber 130 is connected to the first cell accommodating chamber 110 and the second cell accommodating chamber 120. The first cell accommodating chamber 110 is connected to the gas chamber 130 by a first connection portion 21, and the second cell accommodating chamber 120 is connected to the gas chamber 130 by a second connection portion 22. In addition, the first connection portion 21 and the second connection portion 22 may be connected to the gas chamber 130 by a third connection portion 23.

The first cell accommodating chamber 110, the second cell accommodating chamber 120, and the gas chamber 130 may be internally connected by a gas communication port 20. As described above, the gas communication port 20 may be a portion in which a portion of the portions in which the first cell accommodating chamber 110, the second cell accommodating chamber 120, and the gas chamber 130 are connected, are not be sealed, so that an electrolyte may be injected into the first cell accommodating chamber 110 and the second cell accommodating chamber 120 and gas discharged from the first cell accommodating chamber 110 and the second cell accommodating chamber 120 may move to the gas chamber 130. That is, a gas communication port 20 may be formed by the portion in which the first connection portion 21, the second connection portion 22, and the third connection portion 23 are not sealed.

While exemplary embodiments have been illustrated and described above, it will be apparent to those skilled in the art that modifications and variations could be made without departing from the scope of the present invention as defined by the appended claims.

For example, the above-described embodiments may be implemented by deleting some of the components, and the embodiments may be implemented in combination with each other.

1. A method for manufacturing a pouch-type secondary battery, comprising:
preparing a pouch-type case having two first cell accommodating portions for accommodating a first electrode assembly, two second accommodating cell accommodating portions for accommodating a second electrode assembly, and two gas collection portions for accommodating gas;
an accommodating chamber forming operation for forming a first cell accommodating chamber for accommodating the first electrode assembly, the first cell accommodating chamber being formed by folding the two first cell accommodating portions so that the first cell accommodating portions face each other, and a second cell accommodation chamber for accommodating the second electrode assembly, the second cell accommodating chamber being formed by folding the two second cell accommodating portions so that the second cell accommodating portions face each other; and
a gas chamber forming operation for forming a gas chamber by folding the two gas collection portions so that the gas collection portions face each other.

2. The method for manufacturing a pouch-type secondary battery of claim 1, wherein, in a plan view of the pouch-type case while unfolded,
the two first cell accommodating portions and the two second cell accommodating portions are adjacent to each other, respectively, and
any one first cell accommodating portion of the two first cell accommodating portions and any one second cell accommodating portion of the two second cell accommodating portions are adjacent to each other, and
the two gas collection portions are disposed at both ends of the pouch-type case.

3. The method for manufacturing a pouch-type secondary battery of claim 2, wherein in the accommodating chamber forming operation,
the first cell accommodating chamber is formed by folding a first fold portion formed between the two first cell accommodating portions, adjacent to each other, and the second cell accommodating chamber is formed by folding a second fold portion formed between the two second cell accommodating portions, adjacent to each other.

4. The method for manufacturing a pouch-type secondary battery of claim 1, wherein the first cell accommodating chamber is connected to the gas chamber through a first connection portion, and the second cell accommodating chamber is connected to the gas chamber through a second connection portion, and
the first connection portion and the second connection portion are connected to a third connection portion, to be connected to the gas chamber.

5. The method for manufacturing a pouch-type secondary battery of claim 4, wherein a portion of the first connection portion, the second connection portion, and the third connection portion form a gas communication port in an unsealed state, and gas from the first cell accommodating chamber and the second cell accommodating chamber moves to the gas chamber through the gas communication port.

6. The method for manufacturing a pouch-type secondary battery of claim 5, wherein the method for manufacturing a pouch-type secondary battery includes sealing the gas communication port.

7. The method for manufacturing a pouch-type secondary battery of claim 6, wherein the method for manufacturing a pouch-type secondary battery includes
a sealing portion cutting operation for cutting a portion in which the first connection portion, the second connection portion, and the third connection portion are connected.

8. The method for manufacturing a pouch-type secondary battery of claim 7, wherein in the sealing portion cutting operation,
the portion is cut so that the first cell accommodating chamber and the second cell accommodating chamber are connected.

9. The method for manufacturing a pouch-type secondary battery of claim 6, wherein the method for manufacturing a pouch-type secondary battery includes
disposing a support member between the first connection portion and the second connection portion.

10. The method for manufacturing a pouch-type secondary battery of claim 9, wherein the support member has a triangular pillar shape.

11. The method for manufacturing a pouch-type secondary battery of claim 9, wherein the method for manufacturing a pouch-type secondary battery includes
cutting the portion so that the first cell accommodating chamber and the second cell accommodating chamber are separated.

12. An intermediate assembly of a pouch-type secondary battery, comprising:
a plurality of battery including a cell accommodating chamber in which an electrode assembly is accommodated; and
a gas chamber respectively connected to the interior of the plurality of battery cells,
wherein the cell accommodating chamber and the gas chamber are internally connected by a gas communication port.

13. The intermediate assembly of a pouch-type secondary battery of claim 12, wherein the plurality of battery cells include a first cell accommodating chamber and a second cell accommodating chamber;
the first cell accommodating chamber is connected to the gas chamber by a first connection portion, and
the second cell accommodating chamber is connected to the gas chamber by a second connection portion.

14. The intermediate assembly of a pouch-type secondary battery of claim 13, wherein the intermediate assembly of a pouch-type secondary battery includes
a third connection portion connecting the first connection portion, the second connection portion, and the gas chamber.

15. The intermediate assembly of a pouch-type secondary battery of claim 14, wherein the gas communication port is formed in an unsealed portion of the first connection portion, the second connection portion, and the third connection portion.
